(19) United States
(12) Patent Application Publication
(10) Pub. No.: US 2026/0209408 A1
(43) Pub. Date: Jul. 23, 2026

(54) CATALYST FOR POLYETHYLENE POLYMERIZATION

(71) Applicant: SABIC GLOBAL TECHNOLOGIES B.V., Bergen op Zoom (NL)

(72) Inventors: Yahya Banat, Riyadh (SA); Abdalaziz Mohammad A Almuneea, Riyadh (SA); Orass Hamed, Riyadh (SA); Vugar Aliyev, Baku (AZ); Abderrahmane Meddad, Riyadh (SA); Abdulaziz Salem Al-Shehri, Riyadh (SA)

(21) Appl. No.: 19/140,250

(22) PCT Filed: Oct. 27, 2023
(86) PCT No.: PCT/EP2023/080046

§ 371 Date: Jun. 17, 2025

(30) Foreign Application Priority Data
Dec. 20, 2022 (EP) 22215206.8

(51) Int. Cl. C08F 210/02

(52) U.S. Cl. CPC C08F 210/02; C08F 2800/20

(57) ABSTRACT

A process for the preparation of a solid catalyst system, the process including i) providing a chromium compound and optionally a non-chromium metal compound on a silicon oxide support, ii) activating the product of step i) at a temperature of between 450-850° C. for a time between 1-24 hours, iii) reacting an alkyl aluminium compound and a nitrogen containing compound to produce an activator, and iv) mixing the product of step ii) and the activator of step iii). The alkyl aluminum compound is an organo aluminium compound having the formula AlR₃, wherein R is selected from C₁-C₈ alkyl groups. The nitrogen containing compound is a cycloalkylamine compound having the general formula R₂—NH₂, wherein R₂ is selected from optionally substituted C₃-C₈ cycloalkyl groups. The molar ratio of Al:Cr is between 1:1 and 8:1.

### FIELD OF THE INVENTION

The present invention relates to a process for the preparation of a supported chromium based catalyst system for the production of polyethylene, and to the catalyst system obtained thereby. The invention further relates to a process for the production of polyethylene using such catalyst system and polyethylene obtained thereby. The invention further relates to articles made from such polyethylene.

### BACKGROUND OF THE INVENTION

The catalysts for the production processes of polyethylene can be divided in three different subclasses including Ziegler Natta catalysts, Phillips catalysts and single site catalysts. The molecular weight distribution is dictated largely by the catalyst employed. Polydispersities typically range from 2-3 for polyethylene made with single site catalyst, 4-6 for polymer produced with Ziegler-Natta catalyst and 8-20 for polyethylene made with Phillips catalyst.

The Phillips catalyst is a chromium oxide based, heterogeneous catalyst which can be obtained by calcining a chromium compound carried on an inorganic oxide carrier in a non-reducing atmosphere. The purpose of calcination of the chromium catalyst is dehydroxylation of the catalyst support and oxidation of any of the trivalent from of chromium (CrII) to the hexavalent form (CrVI) and then stabilization of the hexavalent form. Phillips-type chromium catalysts are especially suitable for producing polyethylenes with a broad molecular weight distribution and a low level of long chain branching.

Organochromes like silylchromate derived catalysts are also extensively used for commercial PE manufacturing. The silylchromate catalyst consists of silylchromate (bis-triphenylsilyl chromate) absorbed on dehydrated silica and subsequently reduced with for example diethylaluminium ethoxide. The use of silyl chromate as a polymerization catalyst for olefin polymerization is disclosed in for example U.S. Pat. Nos. 3,324,095, 3,324,101 and 3,642,749. Silylchromate produced polyethylenes, under certain situations, have a higher number of benzene residues as compared to polyethylenes produced with chromium oxide based catalyst, which for certain health sensitive applications may limit their use due to regulatory restrictions.

The polymerisation of ethylene with supported chromium based catalysts is disclosed by Kevin Cann in “Comparison of silyl chromate and chromium oxide based olefin polymerisation catalysts” (Macromolecular Symp, 2004, 213, 29-36).

Activators may aid the catalyst performance. U.S. Pat. No. 6,989,344 B2 is directed to the use of aluminum alkyl activators to improve the performance of chromium-based catalysts. The aluminum alkyls act as scavenging agents for poisons to increase the catalyst activity. The aluminum alkyls allow for the variable control of polymer molecular weight, control of side branching while possessing desirable productivities, and may be applied to the catalyst directly or separately to the reactor.

WO 2020/152275 A1 relates to solid catalyst systems comprising a chromium compound, an aluminium alkoxide compound, a nitrogen containing compound and a silicon oxide support, wherein the nitrogen containing compound is a cycloalkylamine compound. The complete catalyst system is prepared before addition to the reactor, however the aluminum alkoxide compound and the nitrogen containing compound are not reacted before being mixed with the chromium compound and the silicon oxide support. Aluminum alkyl compounds are not mentioned.

WO 2022/214420 A1 relates to solid catalyst systems comprising a chromium compound, an aluminium alkoxide compound, a nitrogen containing compound and a silicon oxide support, wherein the nitrogen containing compound may be a cycloalkylamine compound. The reaction product of the aluminium alkoxide and the nitrogen containing compound is first separately prepared, after which the complete catalyst system is prepared before addition to the reactor. Aluminum alkyl compounds are not mentioned.

EP 3715385 A1 relates to a solid catalyst system comprising a first chromium compound, a second chromium compound, a reaction product of an alkyl aluminium compound and a nitrogen containing compound and a silicon oxide support. The first chromium compound is chromium trioxide or a compound convertible to chromium trioxide, the second chromium compound is a silylchromate compound. The nitrogen containing compound is a cycloalkylamine compound. The alkyl aluminium compound may be triisobutyl aluminium. Activation times are not specified.

WO 2016/206911 A1 relates to a process for the production of high density polyethylene by polymerization of ethylene in the presence of a silylchromate based catalyst and a reducing agent. The reducing agent comprises the reaction mixture of an alkyl aluminum compound and a nitrogen containing compound, wherein the alkyl aluminum compound is an organo aluminum compound having the formula AlR3, in which R is a hydrocarbon radical containing 1-10 carbon atom and wherein the nitrogen containing compound is a cycloalkylamine compound. Activation of a chromium compound on a silicon oxide support is not disclosed.

WO 2014/095481 A1 relates to a process for the production of high density polyethylene by polymerisation of ethylene in the presence of a silylchromate based catalyst and a reducing agent and is characterized in that the reducing agent comprises the reaction mixture of an alkyl aluminium compound and/or boron compound and a nitrogen containing compound. The alkyl aluminium compound is an organo aluminium compound having the formula AlR3, in which R is a hydrocarbon radical containing 1-10 carbon atom and the nitrogen containing compound comprises —NH2, —NHR, —NR2, wherein R may be alkyl or a substituted alkyl having from 1 to 40 carbon atoms. A cycloalkyl amine and activation of a chromium compound on a silicon oxide support are not disclosed.

It is well recognized that for certain applications it is advantageous that ethylene polymers have a broad molecular weight distribution (MWD). For example, in blow molding of articles such as bottles, broad MWD polymers are desirable because they exhibit better impact strength and have superior environmental stress crack resistance (ESCR) compared to polymers with narrow molecular weight distribution. There remains a need for polyethylene with even further improved ESCR and impact strength.

It is an objective of the present invention to overcome at least one of the abovementioned disadvantages, or least to provide a useful alternative. Accordingly, it is an objective of the present invention to produce polyethylene with a broad molecular weight distribution. It is a further objective of the present invention to produce polyethylene with an improved ESCR. It is a further objective of the present invention to produce polyethylene with an improved impact strength.

Thereto, the present invention provides a process for the preparation of a solid catalyst system, the process comprising
i) providing a chromium compound and optionally a non-chromium metal compound on a silicon oxide support,
ii) activating the product of step i) at a temperature of between 450-850° C. for a time between 1-24 hours,
iii) reacting an alkyl aluminium compound and a nitrogen containing compound to produce an activator, and
iv) mixing the product of step ii) and the activator of step iii),
wherein the alkyl aluminum compound is an organo aluminium compound having the formula AlR₃, wherein R is selected from C₁-C₈ alkyl groups, and
wherein the nitrogen containing compound is a cycloalkylamine compound having the general formula R₂—NH₂, wherein R₂ is selected from optionally substituted C₃-C₈ cycloalkyl groups, and
   wherein the molar ratio of Al:Cr is between 1:1 and 8:1.

The activator, which comprises the reaction product of the alkyl aluminum compound and the nitrogen containing compound, is thus prepared separately prior to mixing with the activated chromium compound on the silicon oxide support. Surprisingly, use of the inventive catalyst in a polyethylene polymerization process results in polyethylene with improved mechanical properties.

The present invention further provides a solid catalyst system obtained by or obtainable by the process of the invention.

The present invention also provides a process for the production of polyethylene by polymerization of ethylene and an optional comonomer in the presence of the solid catalyst system of the invention, preferably wherein the polymerization is conducted in a gas phase.

The present invention still further provides polyethylene obtained by or obtainable by the process for the production of polyethylene of the invention.

The present invention also provides an article comprising the polyethylene according to the invention. Preferably the article is selected from blow molded articles, films, pipes and geomembranes.

### Activation

The chromium compound and optionally a non-chromium metal compound on a silicon oxide support requires an activation step ii). Activation by calcination can be accomplished by heating the solid catalyst system in steam, dry air or another oxygen containing gas at temperatures up to the sintering temperature of the support.

Preferably, the temperature in step ii) is between 550-750° C.

Preferably, the time in step ii) is between 2-12 hours, more preferably between 3-8 hours.

The chromium compound and optionally a non-chromium metal compound on the silicon oxide support may optionally be reduced after activation using for example, carbon monoxide or a mixture of carbon monoxide and nitrogen.

### Chromium Compound

The chromium compound may be chromium trioxide (i.e. CrO₃) or any compound convertible to chromium trioxide. For compounds convertible to chromium oxide see U.S. Pat. Nos. 2,825,721; 3,023,203; 3,622,251 and 4,011,382. Suitable compounds convertible to chromium oxide include for example, chromium acetyl acetone, chromium chloride, chromium nitrate, chromium acetate, chromium acetate hydroxide, chromium sulfate, ammonium chromate, ammonium dichromate, and other soluble chromium containing salts.

The amount of chromium compound added to the silicon oxide support should be sufficient to obtain between 0.01% and 10%, preferably from 0.1% to 3%, by weight of chromium, calculated as metallic chromium, based on the weight of the silicon oxide support.

One skilled in the art recognizes that a supported chromium oxide based catalyst differs from a silyl chromate catalyst. Preferably, the chromium compound is not silyl chromate. Preferably, the solid catalyst system is free of silyl chromate.

### Non-Chromium Metal Compound

Preferably, the catalyst system further comprises a non-chromium metal compound, i.e. a metal compound which contains a metal which is not chromium. This non-chromium metal compound acts as a modifier and is used for the synthesis of the solid catalyst component according to the invention.

Preferably, the non-chromium compound is a metal halide transition metal compound and is selected from compounds represented by formulas Tm(OR4)nX4-n and Tm(R5)nX4-n, wherein Tm represents a transition metal of Group IVB, VB, or VIB,
R4 and R5 is independently selected from C1-C20 alkyl groups, C1-C20 aryl groups and C1-C20 cycloalkyl groups,
X represents a halogen atom, preferably chlorine and
n represents a number satisfying 0≤n≤4, preferably 1≤n≤4.

Preferably, the metal in the non-chromium metal compound, Tm, is selected from titanium, vanadium, hafnium and zirconium, and is most preferably titanium.

Examples of suitable titanium compounds include titanium alkoxy compounds for example tetraethoxy titanium, tetramethoxy titanium, tetrabutoxy titanium, tetrapropoxy titanium (in particular tetraisopropoxy titanium), tetraisobutoxy titanium, tetrapentoxy titanium, triethoxychloro titanium, diethoxydichloro titanium, trichloethoxy titanium, methoxy titanium trichloride, dimethoxy titanium dichloride, ethoxy titanium trichloride, diethoxy titanium dichloride, propoxy titanium trichloride, dipropoxy titanium dichloride, butoxy titanium trichloride, butoxy titanium dichloride and titanium tetrachloride.

Other suitable non-chromium metal compounds include for example vanadium trichloride, vanadium tetrachloride, vanadium oxytrichloride and zirconium tetrachloride.

Preferably, the amount of the metal in the non-chromium metal compound in the solid catalyst system, in particular the amount of Ti in the solid catalyst system, is between 0.1 and 10.0% by weight, preferably in the range between 0.1 and 6.0% by weight.

Preferably, the weight ratio between the metal in the non-chromium metal compound in the solid catalyst system and Cr is between 0 and 5. In particular the weight ratio of Ti:Cr is preferably between 0:1 and 5:1, more preferably between 0:1 and 3:1.

### Silicon Oxide Support

A silica support that is suitable for use in the present invention has a relatively high surface area and is amorphous.

Preferably, the silicon oxide support has an average particle diameter of 20 to 70 μm, more preferably 30 to 55 μm. The average particle diameter is determined via ASTM D-1921 12.

Preferably, the silicon oxide support has a pore volume of 1.2 to 3.0 m³/kg, more preferably 1.2 to 1.8 m³/kg. The pore volume is determined by ASTM D4284-12 (2012) “Standard Test Method for Determining Pore Volume Distribution of Catalysts and Catalyst Carriers by Mercury Intrusion Porosimetry”.

Preferably, the silicon oxide support has a surface area of 200 to 800 m²/g, more preferably 200 to 400 m²/g. The surface area of the support is determined by the BET nitrogen adsorption method. Test Method: ASTM D 1993-03 (2013) Standard Test Method for Precipitated Silica-Surface Area by Multipoint BET Nitrogen Adsorption. See also references “Adsorption, Surface Area and Porosity” by S. J. Gregg and K. S. W. Sing, Academic Press, London (1982) and “Introduction to Powder Surface Area” by S. Lowell, J. Wiley & Sons, New York, NY, (1979).

Preferably, the silicon oxide support has a pore radius of 120 to 200 Angstrom. The pore radius is determined by ASTM D4284-12 (2012) “Standard Test Method for Determining Pore Volume Distribution of Catalysts and Catalyst Carriers by Mercury Intrusion Porosimetry”.

### Alkyl Aluminum Compound

The alkyl aluminum compound is an organo aluminum compound having the formula AlR₃, wherein R is selected from C₁-C₈ alkyl groups. Suitable examples of organo aluminum compound of the formula AlR₃ include for example trimethyl aluminium, triethyl aluminium, triisobutyl aluminium, tri-n-hexyl aluminium and tri octyl aluminium. Preferably trimethyl aluminium, triethyl aluminium or triisobutyl aluminium is applied, most preferably triisobutylaluminum.

Preferably, the molar ratio of Al:Cr is between 2:1 and 5:1.

### Nitrogen Containing Compound

The nitrogen containing compound is a cycloalkylamine compound having the general formula R₂—NH₂, wherein R₂ represents a cycoalkyl having from 5-20 carbon atoms. The nitrogen containing compound includes substituted derivatives thereof, for example derivatives substituted with one or more alkyl groups, such as methyl and/or ethyl.

Preferably the nitrogen containing compound is an optionally substituted cyclohexylamine. The preparation of the activator with such a nitrogen containing compound is especially uncomplicated. Most preferably, the nitrogen containing compound is cyclohexylamine.

Preferably, the molar ratio of Al to N is >1, more preferably between 2 and 5.

### Polymerization

The catalyst prepared by the process of the invention may be used in both slurry as well as gas phase polymerization processes. Preferably the polymerization is conducted in a gas phase. Gas-phase polymerization processes, such as fluidized bed polymerization, are particularly economical processes for the preparation of polyethylene. Gas-phase polymerization may be carried out in dry mode or condensed mode. Dry mode means that there is no condensation in the loop. Thus, no liquid is formed, and heat is removed from the gas stream without condensation. In condensed mode, a condensing agent is added to remove heat. For example, a condensing agent such as isopentane or isobutene is injected, after which it evaporates, which has a cooling effect and boasts productivity.

The gas phase polymerization process may use any gas phase reactor for gas phase polymerizations and may e.g. be vertically, horizontally mechanically agitated reactor or a fluidized bed reactor.

In general, a fluidized bed gas phase polymerization reactor employs a “bed” of polymer and catalyst which is fluidized by a flow of monomer, comonomer and other optional components which are at least partially gaseous. Heat is generated by the enthalpy of polymerization of the monomers flowing through the bed. Unreacted monomers and other optional gaseous components exit the fluidized bed and are contacted with a cooling system to remove this heat. The cooled gas stream, including monomer, comonomer and optional for example condensable liquids, is then re-circulated through the polymerization zone. Simultaneously, polymer product is withdrawn from the reactor. The reactor temperature in a gas phase process may range between for example 30° C. and 130° C. A description of a gas phase process is disclosed in for example U.S. Pat. Nos. 4,543,399 and 4,588,790.

Suitable fluidized bed reactors include for example a bubbling fluidized bed reactor, a circulating fluidized bed reactor, an annular fluidized bed reactor, a multi-zone fluidized bed reactor and a flash reactor. With ‘fluidized bed’ is meant that an amount of solid particles (in this case preferably the solid catalyst and/or the solid catalyst to which the monomer is attached) in a solid/fluid mixture acts as a fluid. This can be achieved by placing the amount of solid particles under appropriate conditions, for instance by the introduction of fluid through the solid particles at a high enough velocity to suspend the solid particles and causing them to behave as a fluid. An example of a process using a fluidized bed for producing polyolefins is disclosed in U.S. Pat. No. 4,882,400. Other examples of processes using a fluidized bed for producing polyolefins are described in, for example, U.S. Pat. Nos. 3,709,853; 4,003,712; 4,011,382; 4,302,566; 4,543,399; 4,882,400; 5,352,749; 5,541,270; 7,122,607, and 7,300,987.

In the polymerization process according to the invention, the solid catalyst system of the invention is preferably added to a polymerization zone using a dry catalyst feeder. The operation is often carried out under a nitrogen atmosphere and the dry catalyst is transferred to the reactor under positive nitrogen pressure. For methods of feeding a dry catalyst to a polymerization reactor is described for example, in U.S. Pat. Nos. 6,319,995 and 8,431,658.

### Polyethylene

The ethylene polymers obtained with the polymerization process according to the invention may be combined with additives such as for example lubricants, fillers, stabilizers, antioxidants, compatibilizers and pigments. The additives used to stabilize the copolymers may be, for example, additive packages including hindered phenols, phosphites, UV stabilsers, antistatics and stearates.

The ethylene polymers may be extruded or blow-moulded into articles such as for example bottles, containers, fuel tanks and drums, and may be extruded or blown into films.

The polyethylene obtained with the process according to the present invention has properties in the range of:
MFI of from 1 to 15 g/10 min, such as from 5 to 8 g/10 min (according to ASTM D-1238 @190° C., 21.6 kg)
a density ≥935 kg/m³ and ≤955 kg/m³, such as 940 kg/m³ and ≤950 kg/m³ (according to D-1505)
an ESCR of >500 hrs, such as more than 600 or 700 hrs, (according to ASTM D1693), optionally of more than 2000 hrs
an Izod impact strength at room temperature of >250, such as >400 or >500 J/m, with an upper limit of about 1200 J/m (according to ASTM D256)
an Izod impact strength at −30° C. of >80, such as >90 or >100 J/m, with an upper limit of about 400 J/m (according to ASTM D256)
A Charpy impact strength of >100, such as >110 or >115 J/m, with an upper limit of about 250 J/m (according to ASTM D6110)
Strain hardening of >28, such as >30 MPa, with an upper limit of about 60 MPa (according to ISO 18488)

### EXAMPLES

### Activator I

To a round bottom flask, fitted with a stirrer and placed in an oil bath, 248.1 ml of neat triisobutyl aluminum was added, followed by the addition of 591.7 ml of hexane, followed by the addition of 37.6 ml of ml of cylohexylamine, and allowed to mix at a temperature of 65° C. for 30 minutes. The reaction released isobutane gas in the form of bubbles. Triisobutyl aluminum cyclohexylamine was obtained.

### Catalyst A

A silica supported chromium oxide based catalyst with 0.5 wt. % of chromium, a surface area of 300 m²/g and a pore volume of 1.5 cm³/g was activated in an atmosphere of dry air at a temperature of 615° C. for 12 hours using a tube furnace. Then, the catalyst was slurred with isopentane and Activator I was added to the catalyst targeting an Al/Cr molar ratio of 4 (Activator/Cr=34.6).

### Catalyst B

A silica supported chromium oxide based catalyst with 0.5 wt. % of chromium, a surface area of 300 m²/g and a pore volume of 1.5 cm³/g was activated in an atmosphere of dry air at a temperature of 615° C. for 7 hours using a tube furnace. Then, the catalyst was slurred with isopentane and Activator I was added to the catalyst targeting an Al/Cr molar ratio of 4 (Activator/Cr=34.6).

### Catalyst C

A silica supported chromium oxide based catalyst with 0.5 wt. % of chromium, a surface area of 300 m²/g and a pore volume of 1.5 cm³/g was activated in an atmosphere of dry air at a temperature of 615° C. for 4 hours using a tube furnace. Then, the catalyst was slurred with isopentane and Activator I was added to the catalyst targeting an Al/Cr molar ratio of 3.4 (Activator/Cr=29.4).

### Catalyst D

A silica supported chromium oxide based catalyst with 0.5 wt. % of chromium, a surface area of 300 m²/g and a pore volume of 1.5 cm³/g was activated in an atmosphere of dry air at a temperature of 615° C. for 4 hours using a tube furnace. Then, the catalyst was slurred with isopentane and Activator I was added to the catalyst targeting an Al/Cr molar ratio of 3 (Activator/Cr=25.9).

### Comparative Catalyst E

A silica supported chromium oxide based catalyst with 0.5 wt. % of chromium, a surface area of 300 m²/g and a pore volume of 1.5 cm³/g was slurred with isopentane, followed by the addition tetraethoxy titanium. The content was then mixed and subsequently the solvent was dried at 95° C. with nitrogen purge. Then, the catalyst was activated in an atmosphere of dry air at a temperature of 825° C. for 4 hours using a tube furnace.

### Fluid-Bed Polymerization

The supported catalysts A-E were tested in a continuous gas phase fluidized bed reactor having an internal diameter of 45 cm and a reaction zone height of 140 cm. The bed of polymer particles in the reaction zone was kept in a fluidized state by a recycle stream that worked as a fluidizing medium as well as a heat dissipating agent for absorbing the exothermal heat generated within reaction zone. The reactor was kept at a constant temperature and at a constant pressure of about 21.7 bar. Ethylene, hexene, oxygen and hydrogen were used as the raw materials for polymerization. These materials formed a make-up stream.

The solid catalyst compositions were injected directly in the reaction zone of the fluidized bed using purified nitrogen as a carrier gas. The injection rate was adjusted to maintain a constant production rate of about 12 kg/hr. The produced polymer was discharged from the reaction zone semi-continuously via a series of valves into a fixed volume chamber. The so obtained product was purged to remove any volatile hydrocarbons and was then treated with humidified nitrogen to deactivate any trace quantities of residual catalyst composition.

Table 1 below shows the results of the indicated catalysts. All examples show products with improved mechanical properties as compared to the comparative example. Example 2 shows that lowering the catalyst hold time while maintaining the same Al/Cr molar ratio broadens the MWD of the produced resin which resulted in superior ESCR results. Examples 3-5 show that further lowering the catalyst hold time to 4 hours in combination with a lower Al/Cr molar ratio of about 3 resulted in the production of polyethylene with a relatively broad MWD and balanced ESCR and impact results.

TABLE 1

| Reactor Conditions | Ex. 1 | Ex. 2 | Ex. 3 | Ex. 4 | Ex. 5 | C. Ex. 1 |
|---|---|---|---|---|---|---|
| Catalyst | Catalyst | Catalyst | Catalyst | Catalyst | Catalyst | Catalyst |
| | A | B | C | C | D | E |
| Bed temperature (° C.) | 108 | 110 | 110 | 108 | 105 | 107 |
| Reactor pressure (barg) | 20.7 | 20.7 | 20.7 | 20.7 | 20.7 | 20.7 |
| C2 partial pressure (bara) | 15 | 11.5 | 15 | 15 | 11.5 | 15 |
| C6/C2 Flow ratio | 0 | 0 | 0 | 0 | 0 | 0.008 |
| C6/C2 volume ratio | 0.0027 | 0.0047 | 0.0028 | 0.0027 | 0.005 | — |
| H2/C2 volume ratio | 0.02 | 0.02 | 0.02 | 0.15 | 0.15 | 0.04 |
| O2 addback (ppm) | 0.2 | 0.23 | 0.2 | 0.21 | 0.2 | 0.04 |
| MFI (g/10 min) (pellets) | 6.8 | 7.1 | 5.5 | 5.7 | 5.8 | 7.8 |
| Density (g/cc) (pellets) | 0.945 | 0.944 | 0.9435 | 0.9434 | 0.942 | 0.946 |
| Bulk density (kg/m³) | 360 | 324 | 364 | 341 | 353 | 430 |
| Ash (ppm) | <100 | 220 | 120 | 140 | 160 | <100 |
| APS (mm) | 0.59 | 0.41 | 0.43 | 0.53 | 0.53 | 0.5 |
| Fines (%) | 1.76 | 0.64 | 1.5 | 1.2 | 1 | 0.3 |

In Table 1:
C2 = ethylene monomer
H2 = hydrogen
C6 = hexene comonomer
MFI = Melt flow index as measured by ASTM D-1238 (190° C., 21.6 kg)
Density = Density as measured by ASTM D-1505
Bulk density = Bulk density as determined by ASTM D-1895
Ash = Ash as determined by ASTM D-5630
APS = Average particle size as determined by ASTM D-1921
Fines = Amount of fines as determined by ASTM D-1921

TABLE 2

| Product characterization | Ex. 1 | Ex. 2 | Ex. 3 | Ex. 4 | Ex. 5 | C. Ex. 1 |
|---|---|---|---|---|---|---|
| Mn (kDa) | 15 | 9 | 12 | 11 | 10 | — |
| M_{w} | 235 | 320 | 260 | 260 | 250 | — |
| MWD | 15.7 | 35.6 | 21.7 | 23.6 | 26.2 | — |
| Mz (kDa) | 1800 | 2300 | 1700 | 1700 | 1900 | — |
| Mz + 1 | 4700 | 4300 | 3600 | 3600 | 4100 | — |
| CH₃ endgroup (/1000C) | 1.3 | 2.2 | 1.2 | 1.6 | 2.1 | — |
| ethyl branch (/1000C) | 0.3 | 0.5 | 0.3 | 0.4 | 0.7 | — |
| 1-butene (wt. %) | 0.1 | 0.2 | 0.1 | 0.1 | 0.3 | — |
| butyl branch (/1000C) | 1.6 | 2.6 | 1.4 | 1.6 | 2.7 | — |
| 1-hexene (wt. %) | 1 | 1.6 | 0.9 | 0.9 | 1.6 | — |
| hexyl branch (/1000C) | 0.7 | 0.7 | 0.5 | 0.4 | 0.5 | — |
| 1-octene (wt. %) | 0.6 | 0.5 | 0.4 | 0.3 | 0.4 | — |
| Izod Impact @ RT (J/m) | 619 | 644 | 536 | 525 | 570 | 210 |
| Izod Impact @ −30° C. | 237 | 108 | 205 | 225 | 104 | 78 |
| (J/m) | | | | | | |
| Charpy @ −40° C. (J/m) | 128 | 120 | 146 | 135 | 125 | 98.4 |
| Strain hardening (Mpa) | 33 | 33 | 37.5 | 38 | 42 | 26.2 |
| ESCR (hrs) | 792 | >2000 | >1000 | >1000 | >1000 | 96 |

In Table 2:
Mn is the number average molecular weight as determined according to ASTM D-6474 12.
Mw is the weight average molecular weight as determined according to ASTM D-6474 12.
MDW = Mw/Mn (according to ASTM D-6474 12)
Mz and Mz + 1 are higher average molecular weights according to ASTM D-6474 12.

The number of OH₃ end groups, ethyl branches, butyl branches and hexyl branches were determined by ¹³C NMR and values are given per 1000 carbon units. The weight percentages of 1-butene, 1-hexene and 1-octene were subsequently calculated based on these respective values.

A high-temperature chromatograph Polymer Char GPC-IR system equipped with IR5 MCT detector and Polymer Char viscometer (Polymer Char S.A., Spain) was used at 160° C. to determine the MWD and SOB as function of molecular weight. Three columns of Polymer Laboratories 13 μm PLgel Olexis, 300×7.5 mm, were used in series for GPO separation. 1,2,4-trichlorobenzene stabilized with 1 g/L butylhydroxytoluene (also known as 2,6-di-tert-butyl-4-methylphenol or BHT) was used as eluent at a flow rate of 1 mL/min. Sample concentration was around 0.7 mg/mL and injection volume was 200 μL. The molar mass was determined based on the Universal calibration made with PE narrow and broad standards (in the range of 0.5-2800 kg/mol, Mw/Mn −4 to 15) in combination with known Mark Houwink constants of PE-calibrant (alfa=0.725 and log K=−3.391).

Izod impact strength was determined according to ASTM D256.

Charpy impact strength was determined according to ASTM D6110.

Strain hardening was determined according to ISO 18488.

ESCR was determined according to ASTM D1693.

1. A process for the preparation of a solid catalyst system, the process comprising
i) providing a chromium compound, and optionally a non-chromium metal compound, on a silicon oxide support,
ii) activating the product of step i) at a temperature of between 450-850° C. for a time between 3-8 hours,
iii) reacting an alkyl aluminium compound and a nitrogen containing compound to produce an activator, and
iv) mixing the product of step ii) and the activator of step iii),
wherein the alkyl aluminum compound is an organo aluminium compound having the formula AlR₃, wherein R is selected from C₁-C₈ alkyl groups, and
wherein the nitrogen containing compound is a cycloalkylamine compound having the general formula R₂—NH₂, wherein R₂ is selected from optionally substituted C₃-C₈ cycloalkyl groups, and
wherein the molar ratio of Al:Cr is between 1:1 and 8:1.

2. The process according to claim 1, wherein the molar ratio of Al:Cr is between 2:1 and 5:1.

3. The process according to claim 1, wherein the temperature in step ii) is between 550-750° C.

4. The process according to claim 1, wherein the molar ratio of Al to N is >1.

5. The process according to claim 1, wherein the chromium compound is selected from chromium trioxide, chromium acetyl acetone, chromium chloride, chromium nitrate, chromium acetate, chromium acetate hydroxide, chromium sulfate, ammonium chromate and ammonium dichromate.

6. The process according to claim 1, wherein the nitrogen containing compound is optionally substituted cyclohexylamine.

7. The process according to claim 1, wherein the organo aluminium compounds is chosen from the group consisting of trimethyl aluminium, triethyl aluminium, triisobutyl aluminium, tri-n-hexyl aluminium, trioctylaluminium, and combinations thereof.

8. The process according to claim 1, wherein the silicon oxide support has an average particle diameter of 20 to 70 μm as determined by ASTM D-1921, a pore volume of 1.2 to 3.0 m³/kg as determined by ASTM D4284-12 (2012) and/or a surface area of 200 to 800 m²/g as determined by ASTM D 1993-03 (2013).

9. The process according to claim 1, wherein step i) also includes providing a non-chromium metal compound on the silicon support.

10. The process according to claim 9, wherein the weight ratio of Ti:Cr is between 0:1 and 5:1.

11. A solid catalyst system obtained by by the process according to claim 1.

12. A process for the production of polyethylene by polymerization of ethylene and an optional comonomer in the presence of the solid catalyst system of claim 11.

13. A polyethylene obtained by by the process according to claim 12.

14. An article comprising the polyethylene according to claim 13.
